(19) United States
(12) Patent Application Publication
(10) Pub. No.: US 2011/0272051 A1
(43) Pub. Date: Nov. 10, 2011

(54) Damper Arrangement

(75) Inventor: Ulrik Skifter, Bagsvaerd (DK)

(73) Assignee: FLSMIDTH A/S, Valby (DK)

(21) Appl. No.: 13/143,945

(22) PCT Filed: Jan. 12, 2010
(86) PCT No.: PCT/IB10/50099

§ 371 Date: Jul. 11, 2011

(30) Foreign Application Priority Data
Jan. 15, 2009 (DK) PA200900059

(51) Int. Cl. F16L 55/053

(52) U.S. Cl. 138/26

(57) ABSTRACT

A damper arrangement provided in connection with a pipeline for regulating a gas flow being conveyed through the pipeline in a direction. The pipeline over a given distance comprises a branch section, where it is divided into at least two branch pipelines each comprising a damper device that independently of one another can be placed in a fully open position or in a fully closed position. In some embodiments, the branch pipelines after the branch section as seen in the gas conveying direction are united into one single pipeline.

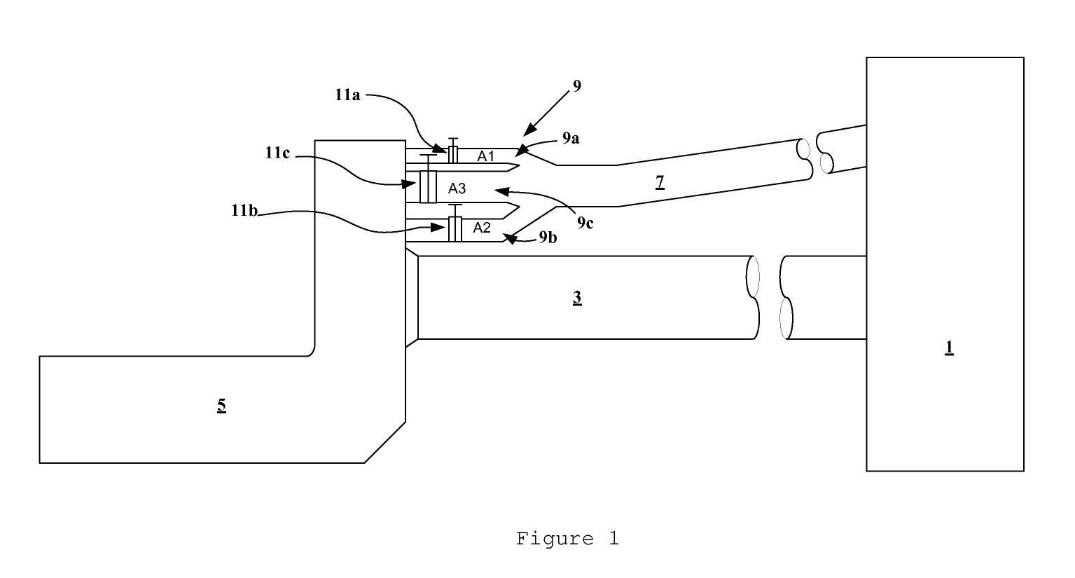

As a result, the wear exposure of the dampers will be significantly reduced, thereby enabling the damper arrangement to maintain its operational reliability even during an extended period of operation while simultaneously allowing for stepwise variable regulation of the gas flow through the pipeline.

### CROSS REFERENCE TO RELATED APPLICATION

This application is the United States national stage under 35 U.S.C. §371 of International Application No. PCT/IB2010/050099, filed on Jan. 12, 2010, which claimed priority to Danish Patent Application No. PA 2009 00059, filed on Jan. 15, 2009. The entirety of these applications is incorporated by reference herein.

### FIELD OF THE INVENTION

The present invention relates to a damper arrangement provided in connection with a pipeline for regulating a gas flow which is conveyed through the pipeline in a direction. Embodiments of the invention may be utilized in cement plants that have a kiln and at least one pipeline, for example.

### BACKGROUND OF THE INVENTION

It is a known practice to utilize an adjustable hoisting damper for performing continuously variable regulation of the pressure loss across a pipeline and hence the gas flow through the pipeline in cement plants. As an illustrative example, it can be mentioned that regulation of the gas flow through the pipeline which is used at a cement plant for conveying hot gases from the clinker cooler to the cyclone preheater is usually performed using such a hoisting damper or a similar continuously variable damper device. However, in actual practice at cement plants it is a proven fact that infinitely variable damper devices such as hoisting dampers will after a short period of operation encounter problems in terms of operational reliability because of the significant wear exposure of the damper in the form of abrasive clinker dust entrained in the hot gases.

### SUMMARY OF THE INVENTION

It is the objective of the present invention to provide a damper arrangement by means of which the aforementioned disadvantage is eliminated or at least substantially reduced.

This is obtained by means of a damper arrangement of the kind mentioned in the introduction and being characterized in that the pipeline over a given distance comprises a branch section, where it is divided into at least two branch pipelines, each comprising a damper device which independently of one another can be placed in a fully open position or in a fully closed position, where the branch pipelines after the branch section as seen in the gas conveying direction are united into one single pipeline.

It is hereby obtained that the wear exposure of the dampers will be significantly reduced, thereby enabling the damper arrangement to maintain its operational reliability even during an extended period of operation while simultaneously allowing for stepwise variable regulation of the gas flow through the pipeline. This is ascribable to the fact that the wear exposure of the dampers will be negligible when they are placed in their fully open and fully closed positions, respectively.

In the most simple embodiment of the damper arrangement according to the invention where it comprises two branch pipelines having the same cross-sectional area and separate dampers, only three setting options will be available, viz. fully closed position where both dampers are closed, semi-closed position where one damper is open and the other one is closed, and fully open position where both dampers are open.

In order to increase the setting options, it is preferred that the damper arrangement comprises branch pipelines having different cross-sectional areas. If the damper arrangement comprises two branch pipelines, one pipeline may for example have a cross-sectional area which is twice the size of the other pipeline, thereby providing the damper arrangement with an additional setting option as compared to the one described above for the simple embodiment.

Furthermore, the damper arrangement may comprise more than two branch pipelines, each comprising a damper device which independently of one another can be placed in a fully open position or in a fully closed position.

In a specific embodiment, the damper arrangement may for example comprise three branch pipelines, as may be appreciated from the FIGURE. The branch pipelines may each be equipped with separate dampers, where the relationship between the cross-sectional areas A1, A2 and A3 for the three branch pipelines will be 1:2:4. Such an embodiment will provide 8 different setting options. It is a foregone conclusion that the number of setting options can be enhanced by increasing the number of branch pipelines.

The dampers which are used for the damper arrangement according to the invention may in principle be of any suitable type which can be placed in a fully open position and a fully closed position, and may consist of ordinary hosting dampers similar to those previously used. The distinctive feature of the present invention is that the dampers are used as on/off dampers and not as hitherto as infinitely variable dampers.

Other details, objects, and advantages of the invention will become apparent as the following description of certain present preferred embodiments thereof and certain present preferred methods of practicing the same proceeds.

### BRIEF DESCRIPTION OF THE DRAWINGS

The invention will now be explained in greater detail with reference to the drawing, being diagrammatical, with its only FIGURE showing a specific embodiment of the damper arrangement according to the invention.

### DETAILED DESCRIPTION OF PRESENT PREFERRED EMBODIMENTS

The FIGURE shows a sectional view of a cement plant comprising a preheater section 1, a rotary kiln 3, a clinker cooler 5 and a pipeline 7 for conveying hot gases from the clinker cooler 5 to the preheater section 1. During operation gases are drawn by means of a common fan (not shown) parallel through the rotary kiln 3 and the pipeline 7 and subsequently mixed in the preheater section. Quite often, it will be desirable to control the relationship between the gases passing through the rotary kiln 3 and the pipeline 7, respectively, which is normally done by adjusting the pressure loss across the pipeline 7 using a damper arrangement 9 provided in connection herewith.

In the embodiment illustrated in the FIGURE for the damper arrangement 9 according to the invention, the pipeline 7 is divided over a given distance into three branch pipelines 9a, 9b and 9c, having cross-sectional areas of A1, A2 and A3, respectively, each comprising a damper device 11a, 11b and 11c, respectively, which independently of one another can be placed in a fully open position or in a fully closed position. If the relationship between the cross-sectional areas A1, A2 and A3 is 1:2:4, the damper arrangement, as indicated in the table below, will be stepwise adjustable for eight different flow areas and hence pressure losses which will determine the volume of gases which can be drawn through the pipeline 7.

| Damper 11a | Damper 11b | Damper 11c | | |
|---|---|---|---|---|
| A1 | A2 | A3 | Total area | |
| 0 | 0 | 0 | 0 | (Fully closed) |
| 1 | 0 | 0 | 1 | |
| 0 | 2 | 0 | 2 | |
| 1 | 2 | 0 | 3 | |
| 0 | 0 | 4 | 4 | |
| 1 | 0 | 4 | 5 | |
| 0 | 2 | 4 | 6 | |
| 1 | 2 | 4 | 7 | (Fully open) |

It is a distinctive advantage of the damper arrangement according to the invention in comparison with ordinarily used infinitely variable damper devices that the wear exposure of the dampers is significantly reduced so that the damper arrangement maintains its operational reliability even during an extended period of operation while simultaneously allowing stepwise variable regulation of the gas flow through the pipeline. This is ascribable to the fact that the wear exposure of the dampers will be negligible when they are placed in fully open or fully closed positions, respectively.

While certain present preferred embodiments of the damper arrangement, cement plants utilizing the damper arrangement, and certain embodiments of methods of practicing the same have been shown and described, it is to be distinctly understood that the invention is not limited thereto but may be otherwise variously embodied and practiced within the scope of the following claims.

1. A damper arrangement provided in connection with a pipeline for regulating a gas flow which is conveyed through the pipeline in a gas conveying direction comprising:
the pipeline comprising a branch section dividing the pipeline into at least two branch pipelines;
each of the branch pipelines comprising a damper device, each damper device moveable from a fully open position to a fully closed position, the damper devices being moveable from the fully open position to the fully closed position independently of one another, the branch pipelines as seen in the gas conveying direction being united into a single pipeline after the branch section.

2. A damper arrangement of claim 1 wherein the branch pipelines have different cross sectional areas.

3. A damper arrangement of claim 1 wherein the branch section has two branch pipelines, one of the branch pipelines having a cross sectional area that is twice the size of the other branch pipeline.

4. A damper arrangement of claim 1 wherein the branch section comprises more than two branch pipelines that each comprise a damper device, each damper device is moveable independent of the other damper devices between the fully open position and the fully closed position.

5. A damper arrangement of claim 2 wherein the branch section comprises three branch pipelines, each of the branch pipelines equipped with separate damper devices where the relationship between cross-sectional areas for the three branch pipelines is 1:2:4.

6. A damper arrangement for a cement plant comprising:
a pipeline, the pipeline having a branch section, the branch section comprising a plurality of branch pipelines;
a plurality of damper devices, each damper device connected to a respective one of the branch pipelines, each of the damper devices being moveable from a fully open position to a fully closed position, the damper devices moving between the fully open position and the fully closed position such that the damper devices are not maintainable at other positions between the fully closed and fully open positions.

7. The damper arrangement for a cement plant of claim 6 further comprising a preheater and a clinker cooler, the pipeline positioned between the clinker cooler and the preheater such that gas flows through the pipeline from the clinker cooler to the preheater, the gas flow being dividable into multiple gas flows by the branch section.

8. The damper arrangement for a cement plant of claim 7 further comprising a kiln positioned between the preheater and the clinker cooler.

9. A cement plant comprising:
a clinker cooler;
a preheater;
a pipeline positioned between the clinker cooler and the preheater, the pipeline having a branch section comprising a plurality of branch pipelines;
a damper arrangement comprising a plurality of damper devices, each of the damper devices positioned in a respective one of the branch pipelines, each of the damper devices being moveable between a fully open position and a fully closed position independent of the other damper devices.

10. The cement plant of claim 9 wherein the damper devices are moveable between the fully open position and the fully closed position such that the damper devices are not maintainable at other positions between the fully closed and fully open positions.

11. The cement plant of claim 9 wherein gas flows through the pipeline from the clinker cooler to the preheater, the gas flow being dividable into multiple gas flows by the branch section.

12. The cement plant of claim 9 wherein each of the branch pipelines has a different cross sectional area.

13. The cement plant of claim 9 wherein the branch pipelines are comprised of a first branch pipeline, a second branch pipeline, and a third branch pipeline, the second branch pipeline having a cross sectional area that is twice as large as the first branch pipeline, the third branch pipeline having a cross sectional area that is four times as large as the first branch pipeline.

14. The cement plant of claim 9 further comprising a kiln positioned between the preheater and the clinker cooler.

15. The cement plant of claim 9 wherein the branch pipelines extend in a gas conveying direction from adjacent the clinker cooler to another section of the pipeline such that the other section of the pipeline defines a single conduit for gas flow through that section of the pipeline, the other section of the pipeline being positioned between the branch section and the preheater.
